(19) United States
(12) Patent Application Publication
(10) Pub. No.: US 2008/0142333 A1
(43) Pub. Date: Jun. 19, 2008

(54) CLUTCH SYSTEM

(76) Inventor: Kyungho Song, Gwangmyeong-city (KR)

Correspondence Address: Kyungho Song, 311-1108, Jugong Apt., Haan 2-dong, Gwangmyeong-city, Gyeonggi-do, omitted

(21) Appl. No.: 11/949,923

(22) Filed: Dec. 4, 2007

(30) Foreign Application Priority Data
Dec. 13, 2006 (KR) 10-2006-0127418

(51) Int. Cl. F16D 19/00

(52) U.S. Cl. 192/89.2; 192/94; 192/99 R

(57) ABSTRACT

A clutch system of a vehicle includes a clutch pedal, a first cable connected to the clutch pedal such that the first cable pivotally interacts with the clutch pedal, a rod connected to the first cable to rotatably interact with the first cable, a guide secured to a fixed element of a vehicle such that the rod moves therethrough, and a fork pivotally interacts with the rod and thus has a simple scheme manufacturing process and costs can be reduced.

### CROSS-REFERENCE TO RELATED APPLICATION

This application claims priority to and the benefit of Korean Patent Application No. 10-2006-0127418 filed in the Korean Intellectual Property Office on Dec. 13, 2006, the entire contents of which are incorporated herein by reference.

### BACKGROUND OF THE INVENTION

(a) Field of the Invention

The present invention relates to a clutch system for a vehicle and, more particularly, to a clutch system that does not utilize hydraulic pressure.

(b) Description of the Related Art

As well known in the art, a clutch system is formed to selectively transmit power generated in an engine of a vehicle.

FIG. 1 shows a clutch system according to the prior art.

According to the clutch system of the prior art, if a clutch pedal 101 is operated by a driver, oil in a master cylinder 103 is transmitted to a release cylinder 105.

Then, a fork 107 is operated and the driving power transmitted from a crankshaft 115 is disconnected when a release lever 109 disengages a pressure plate 113 from a clutch plate 111.

Subsequently, if the driver releases the clutch pedal 101, the driving power transferred from the crankshaft 115 is transmitted by the pressure plate 113 contacting the clutch plate 111.

As described above, because the clutch system utilizes hydraulic pressure according to the prior art, problems occur in that a scheme thereof is complicated and a manufacturing process and costs increase.

In addition, when a hydraulic pressure system is utilized, power delivery efficiency of the clutch pedal is decreased because of pneumatic or structural friction.

Therefore, a clutch system that does not utilize the hydraulic pressure has been developed but it is still problematic in that vibration generated in an engine is transmitted to the clutch pedal.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made in an effort to provide a clutch system having advantages of not transmitting vibration generated in an engine to a clutch pedal.

An exemplary embodiment of the present invention provides a clutch system of a vehicle including a clutch pedal, a first cable connected to the clutch pedal such that the first cable interacts with the clutch pedal, a rod connected to the first cable to rotatably interact with the first cable, a guide being secured to a fixed element of a vehicle and locating the rod therein such that the rod moves forwards and backwards through the guide, and a fork operated by the rod.

A first screw thread is formed to an exterior circumference of the rod.

A second screw thread corresponding to the first screw thread is formed to an interior circumference of the guide.

The second screw thread may be realized as at least one ball.

The clutch system further includes an elastic member and a second cable connected to the rod and the fixed element of the vehicle such that the rod moves to a home position.

The elastic member may be realized as a spring.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 shows a schematic diagram of clutch system according to the prior art;

FIG. 2 shows a clutch system according to an exemplary embodiment of the present invention;

FIG. 3 and FIG. 4 show an operation of a clutch system according to an exemplary embodiment of the present invention; and

FIG. 5 shows a schematic diagram of a portion “A” in FIG. 4.

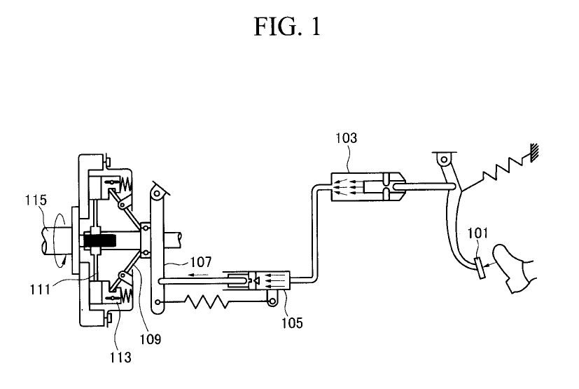

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Reference will now be made in detail to various embodiments of the present invention, examples of which are illustrated in the accompanying drawings and described below. While the present invention will be described in conjunction with exemplary embodiments, it will be understood that present description is not intended to limit the present invention to those exemplary embodiments. On the contrary, the present invention is intended to cover not only the exemplary embodiments, but also various alternatives, modifications, equivalents and other embodiments, which may be included within the spirit and scope of the invention as defined by the appended claims.

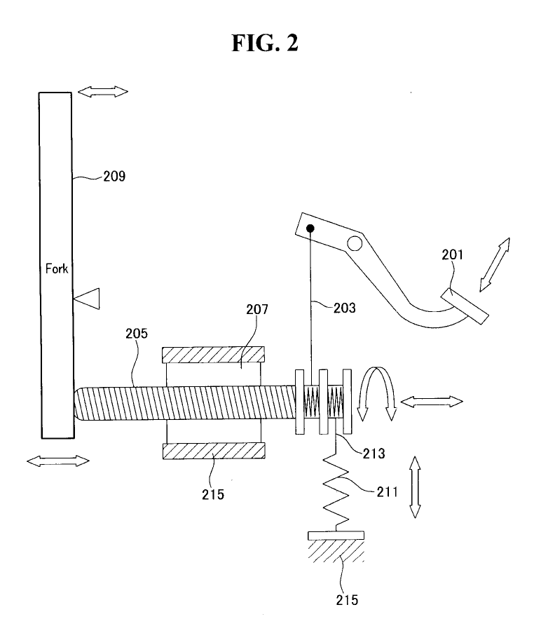

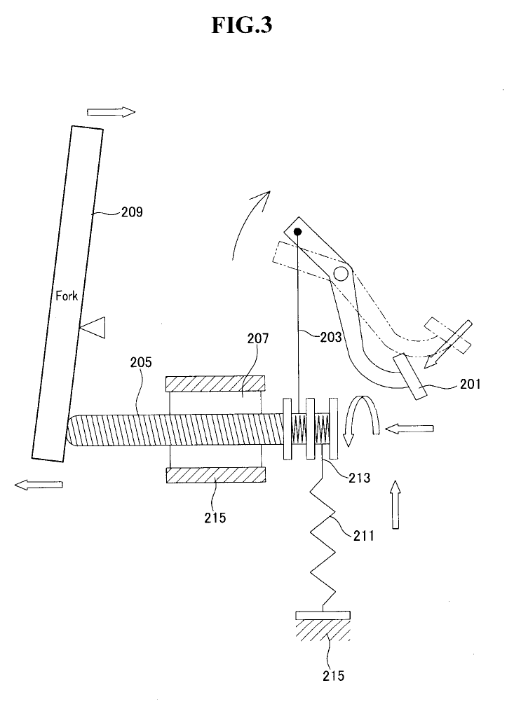

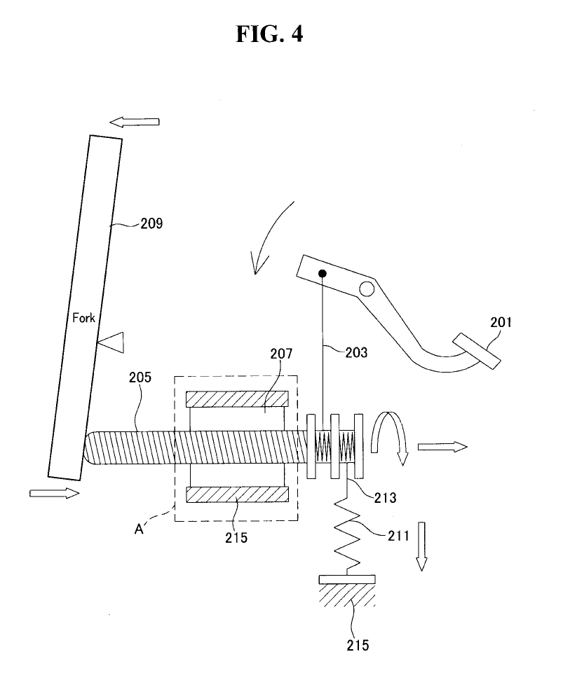

FIG. 2 shows a schematic diagram of clutch system according to an exemplary embodiment of the present invention. FIG. 3 and FIG. 4 show operation of a clutch system according to an exemplary embodiment of the present invention.

As shown in FIG. 2, according to an exemplary embodiment of the present invention, a clutch system includes a clutch pedal 201, a first cable 203, a rod 205, a guide 207, and a fork 209.

The first cable 203 is connected to the clutch pedal 201 to interact with the clutch pedal 201 and the rod 205 is connected to the first cable 203 to rotatably interact with the first cable 203.

The guide 207 in which the rod 205 is located is secured to a fixed element 215 of the vehicle such as a transmission case or a vehicle body such that the rod 205 moves forwards by a rotation of the rod 205.

The fork 209 is pivotally operated by the rod 205.

Referring to FIG. 3, if a driver depresses the clutch pedal 201, the rod 205 rotates by the first cable 203 being pulled upwards (refer to arrows in FIG. 3), and thus the distal end of rod 205 pushes the bottom of fork 209.

As the rod 205 moves in a forward direction while rotating, the clutch (not shown) is disengaged by the fork 209 being pivotally oscillated with respect to a predetermined position.

Because the operation of the clutch is obvious to a person of ordinary skill in the art, the detail description is omitted herein.

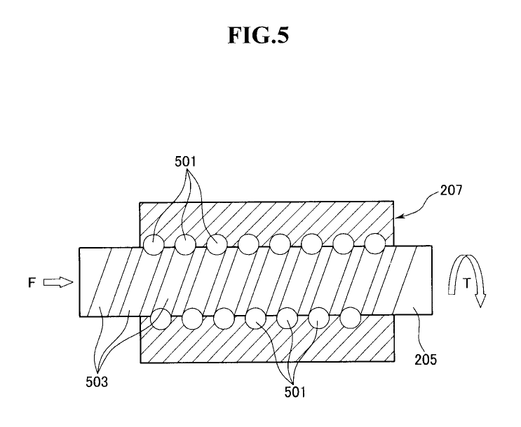

FIG. 5 shows an enlarged perspective view of a portion “A” in FIG. 4.

A first screw thread 503 is formed in an exterior circumference of the rod 205 and a second screw thread 501 corresponding to the first screw thread 503 is formed to an interior circumference of the guide 207.

As the first cable 203 moves upwards by the force of the clutch pedal 201, the rod 205 moves in a forward direction by the operation of first screw thread 503 being relatively rotated with respect to the second screw thread 501.

The second screw thread 501 may be realized as at least one ball.

After the clutch is disengaged, if the driver releases the clutch pedal 201, the rod 205 moves backwards by an elastic member 211 to its home position as illustrated in FIG. 4 as explained below

According to an exemplary embodiment of the present invention, the clutch system further includes an integration of an elastic member 211 and a second cable 213 wherein the distal end of the second cable 213 is connected to the rod 205 and the proximate end of the elastic member 211 is connected to the fixed element 215 of the vehicle such that the rod 205 moves to its home position as the clutch pedal 201 is released.

That is, referring to FIG. 4, if a foot of the driver is removed from the clutch pedal 201, the extended elastic member 211 generates a restoring force and thus the second cable 213 rotates the rod 205 in an opposite direction to that imparted by the first cable 203 (refer to arrows in FIG. 4).

Therefore, the rod 205 moves in the backward direction as shown in the illustrated exemplary embodiment of FIG. 4.

According to an exemplary embodiment of the present invention, the elastic member 211 may be realized as but not limited to a spring.

If vibration is generated in the engine, the vibration may be transmitted to the rod 205 through the fork 209.

However, according to an exemplary embodiment of the present invention, the vibration is not transmitted to the clutch pedal 201 because the first cable 203 absorbs and thus isolates the vibration. In detail, the first cable 203 absorbs the vibration before the vibration energy is transmitted to the clutch pedal 201 because of the flexibility of the first cable 203 and thus first cable 203 functions as a vibration insulator.

Therefore, according to the clutch system of an exemplary embodiment of the present invention, ride comfort and drivability for driver can be improved because the vibration is not transmitted to the clutch pedal.

In addition, because hydraulic pressure system is not utilized, manufacturing process and costs can be reduced.

According to an exemplary embodiment of the present invention, since the scheme is simplified, the manufacturing process and costs may be reduced and power delivery efficiency may be increased since friction among mechanical structures is not reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A clutch system of a vehicle comprising:
a clutch pedal;
a first cable connected to the clutch pedal such that the first cable pivotally interacts with the clutch pedal;
a rod connected to the first cable wherein the rod rotatably interacts with the first cable;
a guide wherein the rod moves through the guide; and
a fork pivotally interacting with the rod.

2. The system of claim 1, wherein the guide is secured to a fixed element of the vehicle.

3. The system of claim 1, wherein a first screw thread is formed onto an exterior circumference of the rod.

4. The system of claim 1, wherein a second screw thread corresponding to the first screw thread is formed to an interior circumference of the guide.

5. The system of claim 4, wherein the second screw is realized as at least a ball.

6. The system of claim 1, further comprising an integral body of an elastic member and a second cable wherein one proximate end of the elastic member is connected to a fixed element of the vehicle and a distal end of the second cable is coupled to the rod such that the rod moves to its home position as a restoring force of the integral body is applied to the rod.

7. The system of claim 6, wherein the elastic member is a spring.
